(19) United States
(12) Patent Application Publication
(10) Pub. No.: US 2024/0403926 A1
(43) Pub. Date: Dec. 5, 2024

(54) ESTIMATE ACQUISITION SYSTEM AND STORAGE MEDIUM

(71) Applicant: KABUSHIKI KAISHA TOSHIBA, Tokyo (JP)

(72) Inventors: Ryosuke SEKIMOTO, Yokohama Kanagawa (JP); Hiroyuki IKEDA, Yokohama Kanagawa (JP); Risa SAKAI, Yokohama Kanagawa (JP); Hideki IDE, Yokohama Kanagawa (JP); Ken YABUI, Setagaya Tokyo (JP)

(21) Appl. No.: 18/597,223

(22) Filed: Mar. 6, 2024

(30) Foreign Application Priority Data
May 29, 2023 (JP) 2023-088187

(51) Int. Cl. G06Q 30/0283; G06Q 10/10

(52) U.S. Cl. CPC G06Q 30/0283; G06Q 10/103

(57) ABSTRACT

An estimate acquisition system includes a clustering part, a preprocessing part, a model equation generation part, a cluster designation part, and a model equation application part. The clustering part clusters previous projects into clusters based on specification information related to the previous projects. The model equation generation part generates a first model and a second model for each of the clusters. Each of the previous project information includes the specification information and information of a cost value including estimate items. The cluster designation part designates, based on specification information of an estimate object project, a cluster among the clusters. The model equation application part is configured to select one of the first model or the second model for the cluster designated by the cluster designation part, and calculate, based on the selected model, a value related to an estimate item of the estimate object project.

### CROSS-REFERENCE TO RELATED APPLICATIONS

This application is based upon and claims the benefit of priority from Japanese Patent Application No. 2023-088187, filed on May 29, 2023; the entire contents of which are incorporated herein by reference.

### FIELD

Embodiments described herein relate generally to an estimate acquisition system and a storage medium.

### BACKGROUND

An expense estimate is presented to a customer when receiving an order for a product, plant, or the like. For example, for a large plant such as a solar power generation system, a rough estimate to study the business profitability is presented to the customer at the initial stage of the study. Estimate acquisition systems that utilize arithmetic processors such as computers and the like have been proposed to calculate such estimates.

For example, Reference 1 (JP-A 2015-099476 (Kokai)) describes a method for calculating an estimate by extracting actual construction results of similar projects from an actual construction result database by using text mining based on specification information of an estimate object project, by performing multiple regression analysis on the extracted actual construction results to determine a function having the specification information as explanatory variables and the man-hours of the estimate items as an objective variable, and multiplying the man-hours determined from the function by a predefined rate.

For example, Patent Literature 2 (JP-A 2019-101681 (Kokai)) is an estimate acquisition device that calculates an estimate by clustering member models used previously, generates an estimate model having the specification information as explanatory variables and the estimate result as an objective variable for each cluster, designates a cluster to which a project similar to the estimate project belongs based on the member models used by the estimate object, and inputs the specification information to a model equation of the designated cluster.

### BRIEF DESCRIPTION OF THE DRAWINGS

FIG. 1 is a schematic block diagram illustrating an estimate acquisition system according to an embodiment;

FIG. 2 is a schematic conceptual view describing project information;

FIG. 3 is a flowchart illustrating a processing procedure of an estimate acquisition system according to the embodiment;

FIG. 4 is an explanatory drawing illustrating processing of the estimate acquisition system according to the embodiment;

FIG. 5 is an explanatory drawing illustrating processing of the estimate acquisition system according to the embodiment; and

FIG. 6 is an explanatory drawing illustrating processing of the estimate acquisition system according to the embodiment.

### DETAILED DESCRIPTION

An estimate acquisition system according to one embodiment, includes a clustering part, a preprocessing part, a model equation generation part, a cluster designation part, and a model equation application part. The clustering part clusters a plurality of previous projects into a plurality of clusters based on specification information related to the plurality of previous projects. The preprocessing part performs preprocessing of a plurality of previous project information related to the plurality of previous projects. The model equation generation part generates a first model and a second model for each of the plurality of clusters based on the plurality of previous project information on which the preprocessing has been performed. Each of the plurality of previous project information includes the specification information and information of a cost value including a plurality of estimate items. The first model represents a correlation between the specification information and a value related to the cost. The second model represents a cost structure corresponding to a relationship between values related to the plurality of estimate items. The cluster designation part designates, based on specification information of an estimate object project, a cluster among the plurality of clusters to which a previous project similar to the estimate object project belongs. The model equation application part is configured to select, based on the specification information of the estimate object project, one of the first model or the second model for the cluster designated by the cluster designation part. The model equation application part is configured to calculate, based on the selected model, a value related to an estimate item of the estimate object project.

Various embodiments are described below with reference to the accompanying drawings.

The drawings are schematic and conceptual, are not necessarily the same as the actual configurations. In the specification and drawings, components similar to those described previously or illustrated in an antecedent drawing are marked with like reference numerals, and a detailed description is omitted as appropriate.

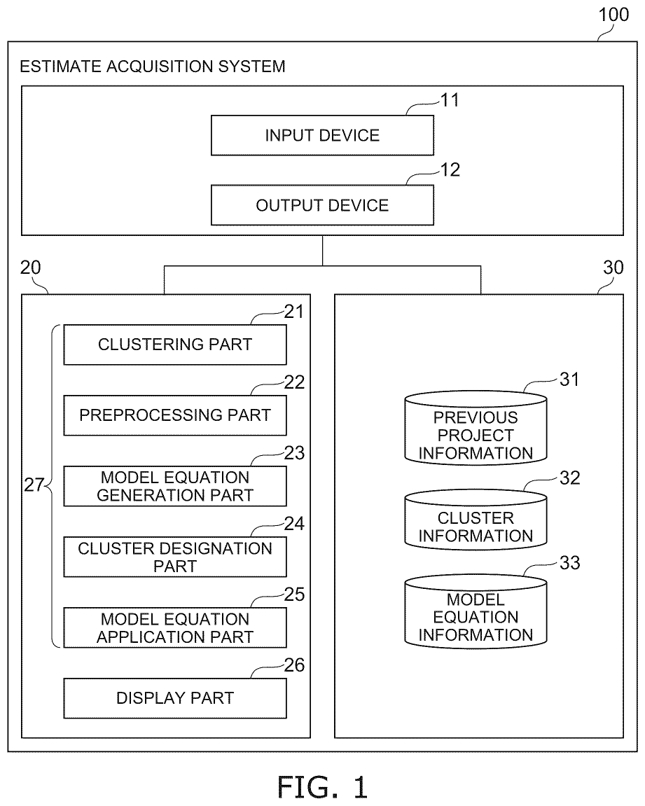

FIG. 1 is a schematic block diagram illustrating an estimate acquisition system according to an embodiment.

As illustrated in FIG. 1, the estimate acquisition system 100 includes an input device 11, an output device 12, an arithmetic device 20, and a storage device 30.

The storage device 30 stores multiple sets of previous project information 31 related to multiple previous projects. “Project” refers to, for example, manufacturing or constructing a product. The range of “project” may include providing products and/or services. The storage device 30 also stores cluster information 32 in which the multiple previous projects are classified into multiple clusters, and model equation information 33 of model equations that model the costs incurred for each of the multiple previous projects.

Specifically, the storage device 30 is, for example, a storage device such as ROM (Read Only Memory) and/or RAM (Random Access Memory). More specifically, the storage device 30 may include nonvolatile memory such as DRAM (Dynamic Random Access Memory), SRAM (Static Random Access Memory), EEPROM (registered trademark) (Electrically Erasable Programmable Read Only Memory), flash memory, etc. The storage device 30 may include a computer-readable storage medium. For example, the storage device 30 also stores an estimate acquisition program that is executed by the estimate acquisition system 100 (a calculation part).

The arithmetic device 20 is configured to communicate with the storage device 30. The arithmetic device 20 includes a calculation part 27 and a display part 26. The calculation part 27 includes a functional block (a clustering part 21, a preprocessing part 22, a model equation generation part 23, a cluster designation part 24, and a model equation application part 25) that performs processing described below. As a result, the calculation part 27 estimates the cost value incurred by the estimate object project based on the previous project information 31, the cluster information 32, and the model equation information 33 stored in the storage device 30.

The clustering part 21 clusters specification information of previous projects. The preprocessing part 22 performs preprocessing of actual result information of the previous projects. The model equation generation part 23 generates, for each cluster classified by the clustering part 21, a model (a second model described below) that represents the cost structure of all of the estimate items based on the actual result information on which the preprocessing part 22 has performed the preprocessing, and a model (a first model described below) that outputs an estimate result for an input of the specification information of the previous projects. The cluster designation part 24 designates, based on the specification information of the estimate object project, a cluster among the clusters classified by the clustering part 21 to which a project similar to the estimate object project belongs. The model equation application part 25 selects, from among the model equations generated by the model equation generation part 23 for the clusters designated by the cluster designation part 24, a model equation that matches the specification information of the estimate object project, and calculates an estimate by inputting the specification information of the estimate object project. The display part 26 displays the estimate result calculated by the model equation application part 25.

Specifically, for example, the calculation part 27 is an arithmetic circuit that includes a CPU (Central Processing Unit), etc. The calculation part 27 may include controllers that control the functions of the estimate acquisition system 100. The calculation part 27 may be configured to read the estimate acquisition program stored in the storage device 30 and to use software to realize various processing described below. The display part 26 is a display device (e.g., a liquid crystal display, an organic EL display, etc.) that displays the estimate results of the calculation part 27.

The input device 11 and the output device 12 are configured to communicate with the arithmetic device 20 and the storage device 30. The input device 11 is an input part that inputs various information such as the previous project information, the estimate object project information, etc., to the estimate acquisition system 100. Specifically, the input device 11 is, for example, a sensor such as a touch panel or the like, a user interface such as a mouse, keyboard, etc. Or, the input device 11 may be a communication module and/or input terminal for receiving information from an external storage device and/or network. The output device 12 outputs the estimate result to the outside. The output device 12 may be, for example, a communication module or output terminal transmitting the estimate result to an external device and/or network.

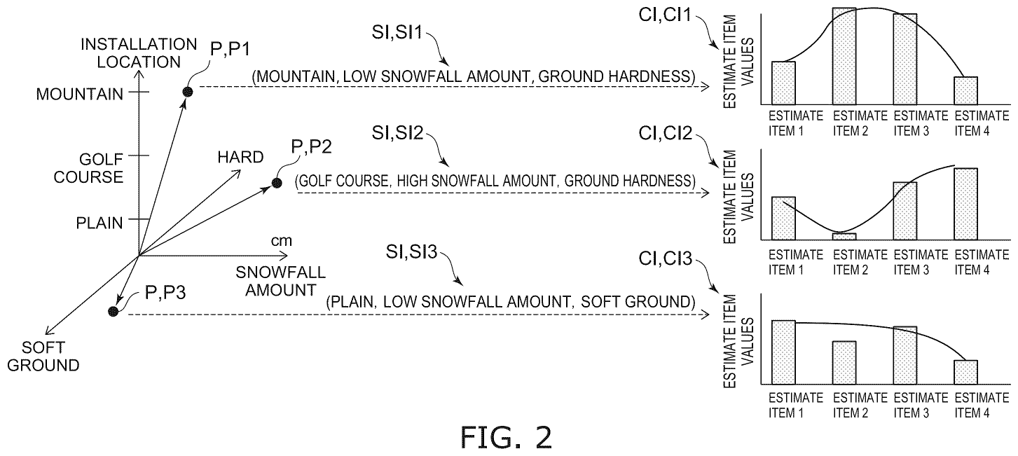

FIG. 2 is a schematic conceptual view describing project information.

Here, as an example, the installation (the construction) of a solar power generation system is assumed as a previous project P. The example of FIG. 2 illustrates a first previous project P1, a second previous project P2, and a third previous project P3 as the multiple previous projects P. The previous project information that is stored in the storage device 30 is information related to the previous projects P. For example, the multiple sets of previous project information includes first previous project information related to the first previous project P1, second previous project information related to the second previous project P2, and third previous project information related to the third previous project P3.

The previous project information of each previous project P includes specification information SI, and information CI of the cost value. For example, the first previous project information related to the first previous project P1 includes first specification information SI1, and information CI1 of the cost value of the first previous project. Similarly, the second previous project information includes second specification information S12, and information CI2 of the cost value of the second previous project. The third previous project information includes third specification information SI3, and information CI3 of the cost value of the third previous project.

The specification information of one project is, for example, information of the required specifications of the one project. For example, the first specification information SI1 that is included in the first previous project information represents the required specifications of the first previous project P1. The specification information SI includes information of multiple specification items (N prescribed specification items). FIG. 2 illustrates three specification items as the multiple specification items, namely the installation location where the solar power generation system is installed, the snowfall amount (e.g., the average snowfall amount per prescribed period) at the location where the solar power generation system is installed, and ground hardness of the location where the solar power generation system is installed. According to the embodiment, the number (N) of specification items included in the specification information SI of the previous project information is not limited to three, and may be any number.

The information of each specification item can be expressed by a parameter (a numerical value). When the specification item is the installation location, for example, the parameters of the installation location may be appropriately defined as discrete values such as 1 for a plain, 2 for a golf course, and 3 for a mountainous region. When the specification item is the snowfall amount, the parameters may be continuous values such as the snow depth (cm). Or, the snowfall amount may be appropriately defined as discrete values such as 1 for a low snowfall amount, and 2 for a high snowfall amount. The information of each specification item may be input as a numerical value, or the necessary information may be extracted and quantified by the calculation part 27.

Thus, the specification information SI of the previous project P is expressed by a combination of the N parameters (the specification values) corresponding to the N prescribed specification items. That is, the specification information SI of the previous project P is data corresponding to points in N dimensional space.

The information CI of the cost value of one previous project P is the value (the actual result value) of the cost actually incurred in the one previous project P. The cost value is the value to be estimated for the estimate object project and is, for example, the expense (the monetary amount). However, the embodiment may estimate not only the expense, but also the period, the amounts of other articles, etc. It is sufficient for the cost (the estimate item) to have a correlation with the specification information and to have a value that changes with the specification information.

The cost includes multiple items (hereinbelow, called “estimate items” for convenience) to be estimated for the estimate object project. The information of the cost value includes the information of the value of each estimate item. The values of the estimate items are, for example, a breakdown of the cost value. In the information CI of the cost value of the previous project P, the value of each estimate item is the value (the actual result value) actually spent on the estimate item.

In the example of FIG. 2, for example, an estimate item 1 is the expense related to some equipment; an estimate item 2 is the expense related to land development; an estimate item 3 is the expense related to foundation work; and an estimate item 4 is the expense related to frame construction. The estimate items are not limited to those described above, and may be expenses for specific materials and/or processing, and can be appropriately set according to the project. The number of estimate items is not limited to four and may be n (n being not less than 2).

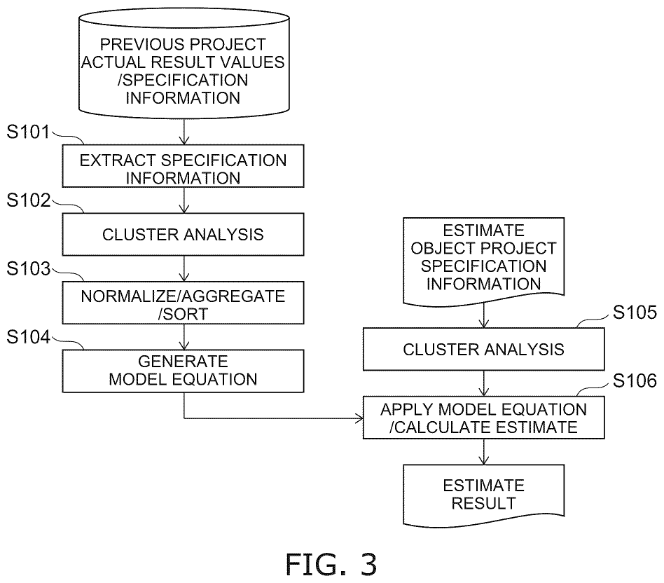

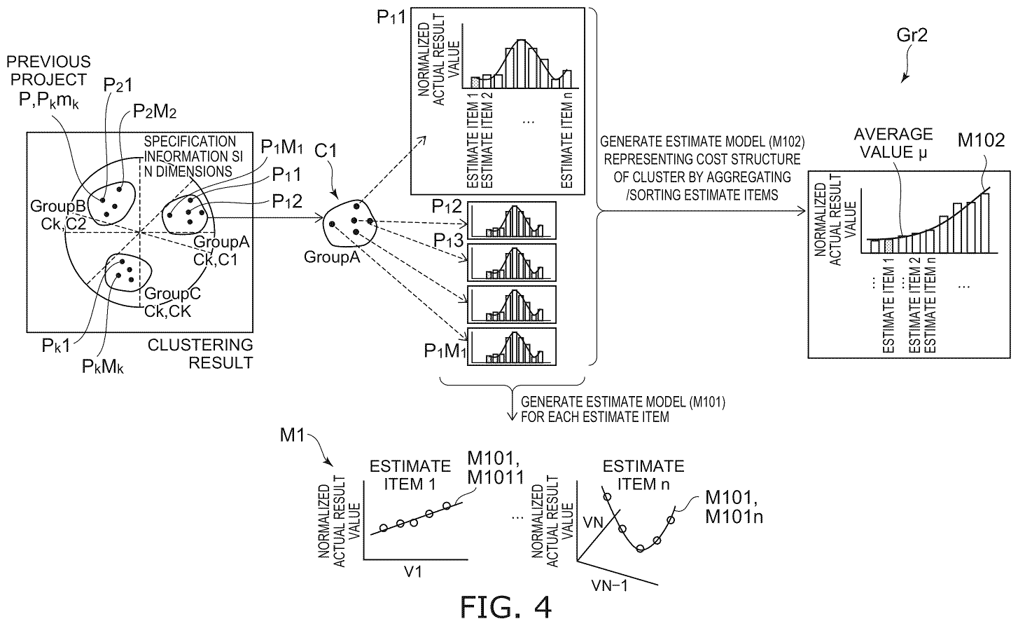

FIG. 3 is a flowchart illustrating a processing procedure of an estimate acquisition system according to the embodiment. FIGS. 4 to 6 are explanatory drawings illustrating processing of the estimate acquisition system according to the embodiment.

For example, as a precondition of starting the processing procedure, all specification information (the information of all specification items) and the actual result values (the values of all estimate items) of the previous projects P are stored in the storage device 30 (the previous project information) in a completed state.

In step S101 as illustrated in FIG. 3, the specification information (e.g., the information of N specification items) necessary for model equation generation is extracted from all specification information of the previous project information. For example, it is taken that the specification information necessary for the model equation generation is predefined. The previous project information from which the specification information is extracted may be selected by a user by considering the implementation period of the previous projects, etc.

Subsequently, the clustering part 21 performs clustering based on one or more types of specification information (specification items) of the selected previous projects. Specifically, for example, in step S102 illustrated in FIG. 3, the previous projects are clustered using the specification information extracted from the selected previous project information. The user may select a known algorithm for the clustering such as, for example, the k-means algorithm, Ward's method, etc. Any number of clusters can be selected by the user. Also, the number of clusters may be determined by considering results of a known technique such as the elbow method, etc. The number of clusters may be automatically determined using a known technique such as the x-means algorithm, etc. The information (the cluster information 32) of the number of clusters, the cluster to which each project belongs, etc., obtained by the clustering is stored in the storage device 30. The actual result values of the projects belonging to each cluster are acquired from the storage device 30 (the previous project information 31).

For example, as illustrated in FIG. 4, the clustering part 21 clusters the multiple previous projects P into multiple clusters Ck based on the specification information SI related to the multiple previous projects P. That is, the clustering part 21 clusters the multiple previous projects P into the multiple clusters Ck based on at least a portion of the information of all specification items (the information of not less than one (e.g., N) specification items). k is an integer of 1 to K representing the cluster number. That is, the multiple clusters Ck include the first to Kth clusters C1 to CK.

The multiple previous projects P are classified into the clusters Ck. In other words, the multiple previous projects P include the mₖth previous project Pₖmₖ that belongs to the cluster Ck. mₖ is an integer of 1 to Mₖ representing the previous project P numbers belonging to the kth cluster Ck.

Specifically, the first to M₁th previous projects P11 to P₁M₁ are classified in a first cluster C1 (a Group A). Similarly, the first to M₂th previous projects P₂1 to P₂M₂ are classified in a second cluster C2 (a Group B). Similarly, the first to M_{K} previous projects P_{K}1 to P_{K}M_{K} are classified in the Kth cluster CK (a Group C).

Subsequently, for example, the preprocessing part 22 uses the parameter that most affects the cost fluctuation to normalize the actual result information of the selected previous projects, calculates the average value and standard deviation of the actual result values of each estimate item for each cluster classified by the clustering part 21, and sorts the estimate items by the average value. For example, in step S103 illustrated in FIG. 3, the parameter that most affects the cost fluctuation is used to normalize the actual result values of the estimate items of the projects. For example, in a solar power generation business, the generation capacity that indicates the power generation scale has the greatest effect on the cost fluctuation, and so the actual result value is normalized using the generation capacity. For each cluster, the normalized actual result values of the projects are used to calculate an average value μ and a standard deviation σ of each estimate item. Subsequently, the estimate items are sorted in ascending order or descending order by the average value u for each cluster.

In other words, for example, the preprocessing part 22 uses a reference value based on the previous project information to normalize the cost value (the values of the estimate items) of the information of each previous project. The reference values may be index values indicating the magnitudes of the cost values of the previous projects P. For example, the reference values may be based on information of at least one specification item of the specification information SI of the previous projects P. Specifically, in each previous project P as described above, the generation capacity (watts) may be used as the reference value. For example, the values of the estimate items of one previous project P are normalized by dividing the values (the actual result values) of the estimate items of the one previous project P by the generation capacity (the reference value) of the one previous project P.

Or, the reference values may be based on the cost values of the previous projects P. For example, in each previous project, the value of the estimate item having the largest value among the multiple estimate items may be used as the reference value. Or, for example, in each previous project P, the value of a prescribed estimate item may be used as the reference value.

More specifically, for example, as in FIG. 4, the values of the estimate items of the first previous project P11 of the first cluster C1 are normalized using a first reference value (e.g., by dividing by the first reference value). The first reference value is based on the first previous project information of the first previous project P11, and is based on, for example, the parameters of the specification items of the first previous project information or the information CI1 of the cost value of the first previous project information.

Similarly, the values of the estimate items of the second to M₁th previous projects P₁2 to P₁M₁ of the first cluster C1 are respectively normalized using the second to Mth reference values. The second to Mth reference values are respectively based on the previous project information of the second to M₁th previous projects P₁2 to P₁M₁.

Similarly to the first cluster C1, for the previous projects P classified into the second to Kth clusters C2 to CK as well, the preprocessing part 22 uses reference values based on the previous project information of the previous projects P to normalize the values of the estimate items.

The normalization may use another method other than dividing the values by reference values. For example, the normalization in each previous project P may be performed by setting the maximum value of the values of the multiple estimate items to 1 and setting the minimum value of the values of the multiple estimate items to 0, or by setting the average value of the multiple estimate items to 0 and setting the standard deviation of the multiple estimate items to 1. According to the embodiment, preprocessing such as normalization and the like may not always be performed, and is omissible or may be performed as necessary.

Continuing now with a description of the processing of the first cluster C1 illustrated in FIG. 4 as an example, the preprocessing part 22 calculates the average value of the first estimate items of M₁ previous projects P included in the first cluster C1 (i.e., the average value of the normalized value of the estimate item 1 of the first previous project P11, the normalized value of the estimate item 1 of the second previous project P₁2, . . . , and the normalized value of the estimate item 1 of the M₁th previous project P₁M₁). The preprocessing part 22 also calculates the standard deviation of the first estimate items of the M₁ previous projects P included in the first cluster C1. Similarly, the preprocessing part 22 calculates the average value and standard deviation of each of the second to nth estimate items of the first cluster C1.

The preprocessing part 22 also performs sorting for the first cluster C1 in which the multiple estimate items are sorted by the calculated average value in descending order (or ascending order). For example, in graph Gr2 illustrated at the right side of FIG. 4, the multiple estimate items are arranged from the left side of the graph in ascending order of the normalized actual result value (the average value of the normalized values of the estimate item).

In other words, the sorting assigns a number (numerical value) of 1 to n to each of the multiple estimate items in descending order (or ascending order) of the average value. For example, in the first cluster C1, the numerical values of 1 to n are assigned to the estimate items in descending order (or ascending order) of the average value so that the estimate item having the greatest average value among the multiple estimate items is set to 1, the estimate item having the second greatest average value is set to 2, . . . , and the estimate item having the nth greatest average value is set to n. In the sorting, one numerical value of 1 to n that indicates the order of the magnitude (smallness) of the average value of each estimate item is assigned to each estimate item.

For example, as in graph Gr2 illustrated in FIG. 4, an estimate model M102 that represents the cost structure is generated from a graph in which the average values of the estimate items are plotted in the sorted order. The order of the model equation representing the cost structure can be reduced by sorting the average values of the estimate items.

The preprocessing part 22 performs similar processing for the second to Kth clusters as well. Namely, for each of the multiple clusters Ck, the preprocessing part 22 calculates the average value and standard deviation of the values related to each of the multiple estimate items for the multiple previous projects P, and sorts the multiple estimate items according to the average values.

Thus, for the clusters Ck, the preprocessing part 22 calculates the average value and standard deviation of the normalized value of the first estimate item for the multiple previous projects P (the first to Mₖ previous projects Pₖ1 to PₖMₖ), the average value and standard deviation of the normalized value of the second estimate item for the multiple previous projects P, . . . , and the average value and standard deviation of the normalization value of the nth estimate item for the multiple previous projects P. For the clusters Ck, the preprocessing part 22 performs sorting in which a number of 1 to n is assigned to each of the multiple estimate items in descending order (or ascending order) of the average value.

Subsequently, for each cluster classified by the clustering part 21, the model equation generation part 23 generates model equations in which, for each estimate item, the specification information is used as the explanatory variables, and the estimate result is used as the objective variable. For example, in step S104 illustrated in FIG. 3, not less than one set of specification information (one specification item) that affects the cost fluctuation is defined for each estimate item. The defined specification information and the normalized actual result value are acquired for each estimate item of the projects included in the clusters; and an estimate model M101 is generated to estimate the cost of each estimate item by performing multiple regression analysis with the normalized actual result value as the objective variable and the specification information as the explanatory variables (see FIG. 4).

In other words, for example, the model equation generation part 23 generates a first model M1 (e.g., the multiple estimate models M101) for each of the multiple clusters Ck based on the multiple sets of previous project information related to the multiple previous projects P. The first model M1 of one cluster Ck is a model representing the correlation between the specification information of the previous projects P of the one cluster Ck and the value related to the cost. In other words, for example, the first model M1 of the first cluster C1 represents the correlation between the specification information of the multiple previous projects P of the first cluster C1 and the value related to the cost of the multiple previous projects P of the first cluster C1. The first model M1 receives input of the specification information, and outputs the value related to the cost as the estimate result.

According to the embodiment, “the value related to the cost” (the value related to the estimate item) is the cost value (the value of the estimate item) such as the monetary amount, the period, etc., which is the final estimate object, and is the value after prescribed conversion processing is performed. In the example, “the value related to the cost” is the normalized cost value as described above. When, however, the conversion processing such as normalization or the like is omitted, the value related to the cost may be the cost value not subjected to a conversion such as normalization, etc.

Specifically, in the example of FIG. 4, the first model M1 (the multiple estimate models M101) includes n estimate models, i.e., the first to nth estimate models M1011 to M101n. The first to nth estimate models M1011 to M101n correspond respectively to the first (estimate item 1) to nth (estimate item n) estimate items.

As illustrated in FIG. 4, the first estimate model M1011 represents a correlation between at least a portion of the information (called a first specification portion) among the N specification items and the value (the normalized actual result value) related to the first estimate item for the multiple previous projects P. In the example of FIG. 4, the first specification portion is one specification item. A specification value V1 is the value of the parameter of the one specification item. The first estimate model M1011 represents the correlation between the specification value V1 and the value related to the first estimate item for the multiple previous projects P.

Similarly, the nth estimate model M101n represents the correlation between at least a portion of the information (called the nth specification portion) among the N specification items and the value (the normalized actual result value) related to the nth estimate item for the multiple previous projects P. In the example of FIG. 4, the nth specification portion is two specification items. The specification value VN-1 and the specification value VN are respectively the values of the parameters of the two specification items. The nth estimate model M101n represents the correlation between the two specification values VN-1 and VN and the value related to the nth estimate item for the multiple previous projects P.

As an example, the jth estimate model M101j (j being an integer of 1 to n) of the kth cluster can be represented by a model equation such as

$$\\ \begin{matrix}{Y}_{kj} = {a}_{kj 1} {x}_{kj 1} + {a}_{kj 2} {x}_{kj 2} + … . & ( 1 )\end{matrix}$$

Here, yₖⱼ is the value related to the jth estimate item. xₖⱼ₁, xₖⱼ₂, . . . , are the specification values of the specification items included in the jth specification portion (at least a portion of the N specification items). αₖⱼ₁, αₖⱼ₂, . . . , are constants. The specification items that are included in the jth specification portion are appropriately determined from the N specification items. The number of specification items included in the jth specification portion is an appropriate number of 1 to N. Each estimate model may be derived by machine learning such as supervised learning, etc. The model equation is not limited to a linear polynomial, and may be, for example, a second or higher order model equation.

For each cluster classified by the clustering part 21, the model equation generation part 23 plots the average values of the estimate items on a graph in the sorted order, and generates a model equation representing the cost structure of the cluster by regression analysis. For example, in step S104 illustrated in FIG. 3, the values of the average value μ of the normalized actual result values determined for each estimate item of each cluster in step S103 are plotted on a graph in the sorted order, and the estimate model M102 that represents the cost structure of the cluster is generated by regression analysis by using the average value μ of the actual result value as the objective variable, and the estimate item as the explanatory variables (see FIG. 4). The order of the estimate model that is generated by sorting the estimate items by the average value μ can be less than before sorting.

In other words, for example, the model equation generation part 23 generates the second model (the estimate model M102) for each of the multiple clusters Ck based on the multiple sets of previous project information related to the multiple previous projects P. The estimate model M102 of one cluster Ck represents the cost structure of the multiple previous projects P belonging to the one cluster Ck. For example, the second model for the first cluster C1 represents the cost structure of the multiple previous projects P of the first cluster C1. The cost structure is the relationship between the values related to the multiple estimate items.

In other words, for example, as in graph Gr2 illustrated in FIG. 4, the estimate model M102 for the first cluster C1 represents the correlation between the numerical values (the number indicating the magnitude order) assigned to the multiple estimate items by the sorting described above for the first cluster C1 and the average value of the values related to the multiple estimate items for the first cluster C1.

As an example, the estimate model M102 of the kth cluster can be represented by a model equation such as

$$\\ \begin{matrix}{Y}_{k} = {α}_{k} {x}^{{}_{} 2} + {β}_{k} x + {γ}_{k} . & ( 2 )\end{matrix}$$

x is the numerical value assigned to the estimate item by the sorting. yₖ is the value (the average value) related to the xth estimate item. αₖ, βₖ, and γₖ are constants. The estimate model may be derived by machine learning such as supervised learning, etc. The model equation is not limited to a quadratic equation and may be, for example, a first-order, third-order, or higher-order model equation.

The cluster designation part 24 performs clustering based on one or more types of specification information (specification items) of the estimate object project, and designates the cluster to which the estimate object project belongs based on the clusters that are clustered by the clustering part 21. Specifically, for example, in step S105 illustrated in FIG. 3, clustering is performed using the specification information of the estimate object project; and the cluster to which the estimate object project belongs is designated. For example, the user uses the input device 11 to input the specification information of the estimate object project. The specification information of the estimate object project that is input may be insufficient for the specification information extracted in step S102. When the specification information is insufficient, a preset (default) value may be fit to the insufficient specification information; and the clustering may be performed using the value.

In other words, the specification information of the estimate object project includes information of at least a portion of the specification items among the N prescribed specification items. The specification information of the estimate object project may include information of all of the N specification items similarly to the previous project P described above, or may include only information of a portion of the specification items among the N specification items. Thus, the specification information of the estimate object project may be insufficient information that does not include information of a portion of the specification items among the N specification items.

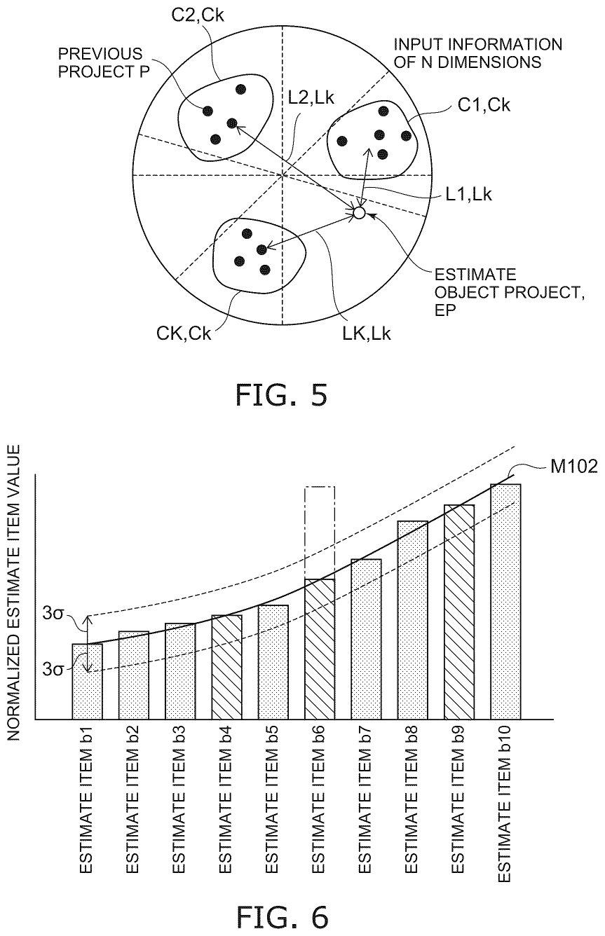

For example, as illustrated in FIG. 5, the cluster designation part 24 calculates distances Lk (e.g., Euclidean distances) between the centroids of the clusters Ck and a point EP that represents the specification information of the estimate object project in N dimensional space formed from the N specification items. In other words, the cluster designation part 24 calculates a distance L1 between the point EP and the centroid of the first cluster C1, a distance L2 between the point EP and the centroid of the second cluster C2, . . . , and a distance LK between the point EP and the centroid of the Kth cluster CK. Then, the cluster designation part 24 designates the cluster Ck having the centroid at the shortest distance from the point EP.

Thus, based on the specification information of the estimate object project, the cluster designation part 24 designates the cluster (the cluster to which the estimate object project belongs) among the multiple clusters Ck to be the cluster to which a previous project similar to the estimate object project belongs.

Based on the specification information of the estimate object project, the model equation application part 25 calculates the estimate by selecting and applying an appropriate model from the model equations generated by the model equation generation part 23. Specifically, for example, in step S106 illustrated in FIG. 3, the estimate is calculated by applying the model equation generated in step S104 to the specification information of the estimate object project input in step S105. The determination of the model equation to be applied is performed for each estimate item. For example, when the specification information that is input in step S105 satisfies the explanatory variables of the estimate model M101 generated in step S104, the estimate is calculated by applying the estimate model M101. For example, when the specification information that is input in step S105 does not satisfy the explanatory variables generated in step S104, the estimate is calculated by applying the estimate model M102.

Thus, based on the specification information of the estimate object project, the model equation application part 25 selects one of the first model (the estimate model M101) or the second model (the estimate model M102) for the cluster designated by the cluster designation part 24, and calculates the value related to the estimate item of the estimate object project based on the selected model.

In other words, the model equation application part 25 performs the processing of calculating the value related to one estimate item among the first to nth estimate items based on one of the estimate model M101 (the first model) or the estimate model M102 corresponding to the one estimate item. The model equation application part 25 performs this processing for each of the multiple estimate items.

FIG. 6 illustrates the calculation of values related to estimate items b1 to b10 by the model equation application part 25. Each of the estimate items b1 to b10 is one of the first to nth estimate items, respectively.

In FIG. 6, the bars with dot hatching show that the value of the estimate item is calculated based on the estimate model M101. The bars with oblique hatching show that the value of the estimate item is calculated based on the estimate model M102.

For example, the estimate model M101 that corresponds to the estimate item b1 is a model that estimates the value related to the estimate item b1 by using the information of at least a portion of the N specification items (called the specification portion of the estimate item b1) as an input. The example of FIG. 6 shows when the specification information of the estimate object project includes the information related to all specification items included in the specification portion of the estimate item b1. In other words, the specification information of the estimate object project satisfies the explanatory variables of the estimate model M101 corresponding to the estimate item b1. In such a case, as illustrated in FIG. 6, the value related to the estimate item b1 is estimated based on the estimate model M101.

For example, the estimate model M101 that corresponds to the estimate item b4 is a model that estimates the value related to the estimate item b4 by using the information of at least a portion of the N specification items (called the specification portion of the estimate item b4) as an input. The example of FIG. 6 shows when the specification information of the estimate object project does not include information related to at least a portion of the specification items included in the specification portion of the estimate item b4. In other words, the specification information of the estimate object project does not satisfy the explanatory variables of the estimate model M101 corresponding to the estimate item b4. In such a case, as illustrated in FIG. 6, the value related to the estimate item b4 is estimated based on the estimate model M102. For example, the numerical value (the number indicating the magnitude order) assigned in the estimate item b4 in the sorting described above is applied to the model equation of the estimate model M102.

Thus, for example, the first estimate model M1011 represents the correlation between the first specification portion, which is at least a portion of the N specification items, and the value related to the first estimate item for the multiple previous projects. When the specification information of the estimate object project includes all specification items included in the first specification portion, the model equation application part 25 selects the first estimate model M1011, and estimates the value related to the first estimate item of the estimate object project by applying the specification information of the estimate project to the first estimate model M1011. On the other hand, when the specification information of the estimate object project does not include at least a portion of the specification items included in the first specification portion, the model equation application part 25 selects the estimate model M102 (the second model), and estimates the value related to the first estimate item of the estimate object project based on the estimate model M102.

The value thus estimated is a value to which the prescribed conversion processing (e.g., the normalization described above) is applied. In step S106, the value to which the prescribed conversion processing is applied may be converted backward as appropriate to calculate the final value of the monetary amount, etc. For example, when the preprocessing part 22 uses the generation capacity to normalize as described above, the estimated value (the normalized value) may be multiplied by the generation capacity of the estimate object project.

Effects of the estimate acquisition system according to the embodiment will now be described.

According to the embodiment as described above, two models, i.e., the first and second models, are generated for each cluster. Then, one of the first or second model is selected for the cluster to which a previous project similar to the estimate object project belongs based on the specification information of the estimate object project; and the value related to the estimate item is calculated based on the selected model. Thus, because the estimate result can be obtained by calculating the estimate based on one of the first or second model, the estimate can be easily acquired. For example, the estimate result can be obtained even when it is difficult to estimate using the other of the first model or the second model. For example, according to the specification information of the estimate object project, etc., the estimate result may be obtained by selecting a more suitable model.

For example, there are cases where an estimate is performed in the initial stage of studying a product or plant when the specifications are vague; in such a case, the estimate is performed based on the experience and knowledge of the estimate personnel, which may result in cases where the estimate results fluctuate between personnel, or it takes much time to calculate the estimate when the estimate conditions are complex. Therefore, an estimate calculation system of a reference example has been proposed in which an arithmetic processor such as a computer or the like is utilized. In the estimate calculation system of the reference example, similar previous actual result information is acquired based on the specification information of the estimate object project; a model equation having the specification information as explanatory variables is generated based on the acquired actual result information; and the estimate is calculated by inputting the specification information of the estimate object to the model equation. However, it is difficult to calculate the estimate when the specification information of the estimate object project that is input does not satisfy the specification information used as the explanatory variables of the model.

In contrast, according to the embodiment, for example, the projects are classified into multiple clusters based on the specification information; and a model equation (the estimate model M101) that estimates the cost of each estimate item and a model equation (the estimate model M102) representing the cost structure of all estimate items of the cluster are generated for each cluster. A cluster to which a similar project belongs is designated based on the specification information of the estimate object project; when the specification information of the estimate object project satisfies the explanatory variables of the estimate model M101, the model equation of the estimate model M101 is applied; and when the specification information of the estimate object project is insufficient, the model equation of the estimate model M102 is applied. As a result, for example, a quantitative and efficient estimate is possible even for insufficient items of the specification information at the estimate stage. For example, even when the specification information is insufficient, a quantitative rough estimate can be calculated based on previous actual results; and the man-hours to calculate the estimate can be reduced.

According to the embodiment, the preprocessing part 22 normalizes the cost value of each of the multiple sets of previous project information based on each of the multiple sets of previous project information. As a result, for example, even when the scales of the multiple previous projects are different from each other, it is easy to collectively handle the data of the multiple previous projects; and models can be generated. Furthermore, the preprocessing part 22 sorts the multiple estimate items by the average values as described above. The order of the model equation can be reduced thereby. For example, for each cluster Ck, the model equation generation part 23 generates the second model by plotting the relationship between the order of the multiple estimate items sorted by the preprocessing part 22 and the average values of the values related to the multiple estimate items on a graph, and by performing regression analysis. The order of the model equation can be reduced thereby.

According to the embodiment, the estimate result is calculated by performing the determination of model selection for each estimate item. In other words, for example, based on the specification information of the estimate object project, the model equation application part 25 selects one of the estimate model M101 or the estimate model M102 corresponding to one of the multiple estimate items. Then, the model equation application part 25 calculates the value related to the one of the multiple estimate items based on the selected model. The model equation application part 25 performs this processing for each estimate item. As a result, a more suitable model can be estimated for each estimate item.

According to the embodiment, for example, the estimate object project can be classified into a group of similar projects automatically by inputting the specification information of the estimate object project. For example, by switching the model equation that is applied according to the condition of the specification information that is input, the estimate can be calculated even when the specification information is insufficient in the initial stage of the estimate.

The example of FIG. 6 shows when the specification information of the estimate object project satisfies the explanatory variables of the estimate model M101 corresponding to the estimate item b6. The bar illustrated by a single dot-dash line at the estimate item b6 of FIG. 6 illustrates an estimate value of the estimate item b6 calculated based on the estimate model M101 corresponding to the estimate item b6. Here, as in the example of FIG. 6, when the estimate value based on the estimate model M101 is different from the trend of the cluster, the estimate value may be treated as an outlier; and the estimate value may be calculated based on the estimate model M102.

For example, the estimate value based on the estimate model M101 is deemed to be an outlier when the difference between the estimate value of the estimate item calculated based on the estimate model M102 and the estimate value of the estimate item calculated based on the estimate model M101 is greater than a prescribed value. For example, the prescribed value can be determined based on the standard deviation σ, e.g., 3σ, of the estimate item calculated by the preprocessing part 22.

The confidence level of the estimate model M101 corresponding to the estimate item may be calculated based on the standard deviation σand/or sample size of the estimate item. For example, the confidence level increases as the standard deviation σdecreases; and the confidence level increases as the sample size increases. The confidence level may be used as appropriate for outlier determination of the estimate value of the estimate item based on the estimate model M101. For example, the estimate value of the estimate item based on the estimate model M101 that has a confidence level less than a prescribed value is determined to be an outlier. When the estimate item is determined to be an outlier based on the estimate model M101, the estimate value based on the estimate model M102 may employed for the estimate item.

The components such as the functional blocks described in the embodiment, etc., are functionally conceptual, and may not always be physically configured as illustrated. Some or all of the multiple functional blocks may be aggregated as appropriate, or each functional block may be subdivided into a plurality. A portion of each functional block may be moved into another block. The components of the embodiment may be functionally or physically dispersed or integrated as appropriate.

The embodiment may be an estimate acquisition program that, when executed by a computer, causes the computer to perform the estimate acquisition method described with reference to the flowchart described above. The estimate acquisition system 100 performs the processing described above based on the estimate acquisition program. However, the entirety or a portion of the estimate acquisition method according to the embodiment may be performed based on a hardware operation that does not require a program.

The program is not limited to a program configuration (a configuration located in the computer) that, when executed by the computer, causes the computer to perform the method described above, and may have the configuration of a computer readable recording medium. For example, CD-ROM (-R/-RW), a magneto-optical disk, a HD (hard disk), DVD-ROM (-R/-RW/-RAM), a FD (flexible disk), flash memory, other similar recording medium, other various ROM, RAM, etc., can be used as the recording medium. The storage format may have any configuration as long as the recording medium is readable by a computer or embedded system. A computer can realize operations similar to those of the embodiment described above by reading a program from a recording medium, and by causing a CPU to execute the instructions described in the program based on the program. Of course, when the computer acquires or reads the program, the computer may acquire or read the program via a network.

A portion of the processing for realizing the embodiment may be performed by an OS (operating system) or database management software operating on a computer or embedded system based on instructions of a program installed from a recording medium in the computer or embedded system, MW (middleware) operating on a network, etc.

According to the embodiment, the recording medium is not limited to a recording medium independent of a computer or embedded system, and includes a program transmitted by a LAN, the Internet, etc., downloaded, and stored or temporarily stored in a recording medium. The recording medium is not limited to one recording medium; and processing according to the embodiment that is performed from multiple recording media also is included in the recording medium according to the embodiment. The configuration of the recording medium may be any configuration.

The computer or embedded system according to the embodiment performs the processing according to the embodiment based on a program stored in a recording medium, and may have any configuration such as a device made of one personal computer, microcomputer, or the like, a system of multiple devices connected by a network, etc.

According to the embodiment, “computer” is not limited to a personal computer, but also includes an arithmetic processor, microcomputer, etc., included in an information processing device, and generally refers to equipment or a device that can use a program to realize the functions according to the embodiment.

Embodiments may include the following configurations.

### Configuration 1

1. An estimate acquisition system, comprising:
   a clustering part clustering a plurality of previous projects into a plurality of clusters based on specification information related to the plurality of previous projects;
   a preprocessing part performing preprocessing of a plurality of previous project information related to the plurality of previous projects;
   a model equation generation part generating a first model and a second model for each of the plurality of clusters based on the plurality of previous project information on which the preprocessing has been performed, each of the plurality of previous project information including the specification information and information of a cost value including a plurality of estimate items, the first model representing a correlation between the specification information and a value related to the cost, the second model representing a cost structure corresponding to a relationship between values related to the plurality of estimate items;
   a cluster designation part designating, based on specification information of an estimate object project, a cluster among the plurality of clusters to which a previous project similar to the estimate object project belongs; and
   a model equation application part configured to
      select, based on the specification information of the estimate object project, one of the first model or the second model for the cluster designated by the cluster designation part, and
      calculate, based on the selected model, a value related to an estimate item of the estimate object project.

### Configuration 2

The system according to Configuration 1, wherein
the preprocessing part normalizes the cost values of the plurality of previous project information respectively based on the plurality of previous project information.

### Configuration 3

The system according to Configuration 2, wherein
the preprocessing part calculates, for each of the plurality of clusters, an average value of values related to each of the plurality of estimate items for the plurality of previous projects, and
the preprocessing part sorts the plurality of estimate items according to the average values.

### Configuration 4

The system according to Configuration 3, wherein
the model equation generation part generates, for each of the plurality of clusters, the second model based on a relationship between
   an order of the plurality of estimate items sorted by the preprocessing part, and
   the average values of the values related respectively to the plurality of estimate items.

### Configuration 5

The system according to any one of Configurations 1 to 4, wherein
the first model includes a plurality of estimate models,
each of the plurality of estimate models represents a correlation between the specification information of the plurality of previous projects and values related respectively to the plurality of estimate items, and
for each of the plurality of estimate items, the model equation application part
   selects, based on the specification information of the estimate object project, one of the second model or an estimate model among the plurality of estimate models corresponding to one of the plurality of estimate items, and
   calculates, based on the selected model, a value related to the one of the plurality of estimate items of the estimate object project.

### Configuration 6

The system according to Configuration 5, wherein
the specification information of each of the plurality of previous projects includes information of a plurality of specification items,
the plurality of estimate models includes a first estimate model corresponding to a first estimate item,
the first estimate model represents a correlation between a first specification portion and a value related to the first estimate item of the plurality of previous projects, the first specification portion being at least a portion of the plurality of specification items,
when the specification information of the estimate object project includes all specification items included in the first specification portion, the model equation application part
   selects the first estimate model, and
   estimates a value related to the first estimate item of the estimate object project by applying the specification information of the estimate object project to the first estimate model, and
when the specification information of the estimate object project does not include at least a portion of specification items included in the first specification portion, the model equation application part
   selects the second model, and
   estimates the value related to the first estimate item of the estimate object project based on the second model.

### Configuration 7

A storage medium,
the storage medium being computer-readable,
the storage medium being configured to store an estimate acquisition program,
the estimate acquisition program, when executed by a computer, causing the computer to:
   cluster a plurality of previous projects into a plurality of clusters based on specification information related to the plurality of previous projects;
   perform preprocessing of a plurality of previous project information related to the plurality of previous projects;
   generate a first model and a second model for each of the plurality of clusters based on the plurality of previous project information on which the preprocessing has been performed, each of the plurality of previous project information including the specification information and information of a cost value including a plurality of estimate items, the first model representing a correlation between the specification information and a value related to the cost, the second model representing a cost structure corresponding to a relationship between values related to the plurality of estimate items;
   designate, based on specification information of an estimate object project, a cluster among the plurality of clusters to which a previous project similar to the estimate object project belongs;
   select, based on the specification information of the estimate object project, one of the first model or the second model for the designated cluster, and
   calculate, based on the selected model, a value related to an estimate item of the estimate object project.

According to embodiments, an estimate acquisition system and an estimate acquisition program can be provided in which an estimate can be easily acquired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An estimate acquisition system, comprising:
a clustering part clustering a plurality of previous projects into a plurality of clusters based on specification information related to the plurality of previous projects;
a preprocessing part performing preprocessing of a plurality of previous project information related to the plurality of previous projects;
a model equation generation part generating a first model and a second model for each of the plurality of clusters based on the plurality of previous project information on which the preprocessing has been performed, each of the plurality of previous project information including the specification information and information of a cost value including a plurality of estimate items, the first model representing a correlation between the specification information and a value related to the cost, the second model representing a cost structure corresponding to a relationship between values related to the plurality of estimate items;
a cluster designation part designating, based on specification information of an estimate object project, a cluster among the plurality of clusters to which a previous project similar to the estimate object project belongs; and
a model equation application part configured to
select, based on the specification information of the estimate object project, one of the first model or the second model for the cluster designated by the cluster designation part, and
calculate, based on the selected model, a value related to an estimate item of the estimate object project.

2. The system according to claim 1, wherein
the preprocessing part normalizes the cost values of the plurality of previous project information respectively based on the plurality of previous project information.

3. The system according to claim 2, wherein
the preprocessing part calculates, for each of the plurality of clusters, an average value of values related to each of the plurality of estimate items for the plurality of previous projects, and
the preprocessing part sorts the plurality of estimate items according to the average values.

4. The system according to claim 3, wherein
the model equation generation part generates, for each of the plurality of clusters, the second model based on a relationship between
an order of the plurality of estimate items sorted by the preprocessing part, and
the average values of the values related respectively to the plurality of estimate items.

5. The system according to claim 1, wherein
the first model includes a plurality of estimate models,
each of the plurality of estimate models represents a correlation between the specification information of the plurality of previous projects and values related respectively to the plurality of estimate items, and
for each of the plurality of estimate items, the model equation application part
selects, based on the specification information of the estimate object project, one of the second model or an estimate model among the plurality of estimate models corresponding to one of the plurality of estimate items, and
calculates, based on the selected model, a value related to the one of the plurality of estimate items of the estimate object project.

6. The system according to claim 5, wherein
the specification information of each of the plurality of previous projects includes information of a plurality of specification items,
the plurality of estimate models includes a first estimate model corresponding to a first estimate item,
the first estimate model represents a correlation between a first specification portion and a value related to the first estimate item of the plurality of previous projects, the first specification portion being at least a portion of the plurality of specification items,
when the specification information of the estimate object project includes all specification items included in the first specification portion, the model equation application part selects the first estimate model, and
estimates a value related to the first estimate item of the estimate object project by applying the specification information of the estimate object project to the first estimate model, and
when the specification information of the estimate object project does not include at least a portion of specification items included in the first specification portion, the model equation application part
selects the second model, and
estimates the value related to the first estimate item of the estimate object project based on the second model.

7. A storage medium,
the storage medium being computer-readable,
the storage medium being configured to store an estimate acquisition program,
the estimate acquisition program, when executed by a computer, causing the computer to:
cluster a plurality of previous projects into a plurality of clusters based on specification information related to the plurality of previous projects;
perform preprocessing of a plurality of previous project information related to the plurality of previous projects;
generate a first model and a second model for each of the plurality of clusters based on the plurality of previous project information on which the preprocessing has been performed, each of the plurality of previous project information including the specification information and information of a cost value including a plurality of estimate items, the first model representing a correlation between the specification information and a value related to the cost, the second model representing a cost structure corresponding to a relationship between values related to the plurality of estimate items;
designate, based on specification information of an estimate object project, a cluster among the plurality of clusters to which a previous project similar to the estimate object project belongs;
select, based on the specification information of the estimate object project, one of the first model or the second model for the designated cluster, and
calculate, based on the selected model, a value related to an estimate item of the estimate object project.
